(19) United States
(12) Patent Application Publication
(10) Pub. No.: US 2021/0206938 A1
(43) Pub. Date: Jul. 8, 2021

(54) METHOD FOR PRODUCING POROUS SILICONE MATERIALS

(71) Applicants: Elkem Silicones France SAS, Lyon (FR); Institut National des Sciences Appliquees de Lyon, Villeurbanne (FR); Universite Claude Bernard Lyon I, Villeurbanne (FR); Centre National de la Recherche Scientifique - CNRS, Paris (FR); Universite Jean Monnet Saint Etienne, Saint Etienne (FR)

(72) Inventors: Francois GANACHAUD, (US); Etienne FLEURY, (US); Gabriel LARRIBE, (US); David MARIOT, (US); Frederic MARCHAL, (US)

(73) Assignees: Elkem Silicones France SAS, Lyon (FR); Institut National des Sciences Appliquees de Lyon, Villeurbanne (FR); Universite Claude Bernard Lyon I, Villeurbanne (FR); Centre National de la Recherche Scientifique - CNRS, Paris (FR); Universite Jean Monnet Saint Etienne, Saint Etienne (FR)

(21) Appl. No.: 17/250,067

(22) PCT Filed: May 17, 2019
(86) PCT No.: PCT/FR2019/051134

§ 371 Date: Nov. 18, 2020

(30) Foreign Application Priority Data
May 18, 2018 (FR) 1854150

(51) Int. Cl. C08J 9/00; C08L 83/04; C08J 9/28

(52) U.S. Cl. CPC C08J 9/0061; C08L 83/04; C08J 2483/04; C08J 2201/026; C08J 2383/04; C08J 2471/02; C08J 2201/0504; C08J 9/283

(57) ABSTRACT

A method for producing a porous silicone material including the following steps:
1) implementing a direct emulsion E of silicone in water including:
   A) a silicone base A crosslinkable by polyaddition or polycondensation;
   B) at least one nonionic silicone surfactant B having a cloud point between 10 and 50° C.;
   C) optionally, at least one catalyst C; and
   D) water;
2) heating the emulsion E to a temperature greater than or equal to 60° C. to obtain a porous silicone material; and
3) optionally, drying the porous silicone material.

### FIELD OF THE INVENTION

The invention relates to a method for producing a porous silicone material. In particular, the invention relates to a method for producing a porous silicone material using a direct emulsion of silicone in water. The invention also relates to a porous silicone material as well as to a direct emulsion of silicone in water.

### TECHNOLOGICAL BACKGROUND

Porous silicone materials are used in many technical fields, especially in the field of insulation indeed, these materials have good mechanical properties and good thermal stability, and can be used as thermal, mechanical, or sound insulation.

There are different techniques for producing porous silicone materials. Among these techniques are methods making use of an emulsion comprising a silicone phase and an aqueous phase.

Patent application EP 1724308 describes an emulsion for producing an elastomeric silicone foam. This emulsion comprises (A) a silicone base, capable of addition-curing, containing a diorganopolysiloxane comprising at least two alkenyl groups per molecule, an organopolysiloxane comprising at least two Si—H bonds, and a platinum catalyst, (B) an aqueous solution comprising a water-soluble polymer, and (C) an emulsifying agent.

Most often, the emulsions used to produce a porous silicone material are invert emulsions, meaning emulsions of water (or other blowing agent) in a silicone phase. The formation of the porous silicone material takes place by crosslinking of the silicone phase, then evaporation of the blowing agent. Invert emulsions are of interest because they make it possible to easily produce porous silicone materials. However, the use of invert emulsion poses several problems, one of the major problems being the stability of the emulsions. As invert emulsions are not very stable, they cannot be stored for a long time, so they must be used soon after production. This is problematic when the emulsion production site is remote from the site where the emulsion is used. Furthermore, the reactivity of invert emulsions induces premature crosslinking phenomena which are detrimental, Invert emulsions are also very viscous, which can pose a problem if one wishes to coat a support with this emulsion. Finally, it is not always easy to control the porosity or density of the porous silicone material obtained. These parameters are important because they influence the properties of the material.

In this context, one aim of the present invention is to provide a method for producing a porous silicone material overcoming at least one of these disadvantages.

Another aim of the present invention is to provide a method for producing a porous silicone material which is simple to implement.

Another aim of the present invention is to provide a method for producing a porous silicone material from a direct emulsion of silicone in water.

Another aim of the present invention is to provide a method for producing a porous silicone material which makes it possible to control the porosity and/or the density of the material obtained.

Another aim of the present invention is to provide a method for producing a porous silicone material which is of good quality.

Another aim of the present invention is to provide an emulsion which is stable for producing a porous silicone material.

Another aim of the present invention is to provide a direct emulsion for producing a porous silicone material.

### BRIEF DESCRIPTION OF THE INVENTION

These aims, among others, have been achieved by means of a method for producing a porous silicone material comprising the following steps:
1) implementing a direct emulsion E of silicone in water comprising:
   A) a silicone base A crosslinkable by polyaddition or polycondensation;
   B) at least one nonionic silicone surfactant B having a cloud point comprised between 10 and 50° C., preferably between 15 and 415° C.;
   C) optionally, at least one catalyst C; and
   D) water;
2) heating the emulsion E to a temperature greater than or equal to 60° C. to obtain a porous silicone material; and
3) optionally, drying the porous silicone material, preferably by heating.

The use of a nonionic silicone surfactant B having a cloud point comprised between 10 and 50° C. allows making use of a direct emulsion to produce a porous silicone material. As direct emulsions are more stable than invert emulsions, the storage and premature crosslinking issues are avoided. In addition, direct emulsions are easy to manipulate and their viscosity can more easily be controlled.

Furthermore, the method is simple to implement. As long as the emulsion E is not heated, the silicone base does not crosslink. The heating step 2) enables destabilization, or even inversion, of the emulsion. Indeed, the hydrophilicity of the nonionic silicone surfactant B decreases with the temperature, the surfactant B then gains affinity for the silicone phase and no longer acts as a surfactant. The silicone base A then crosslinks to form the porous silicone material, trapping water in the pores of the material. It is then possible to dry the obtained material to remove the water. The porous silicone materials obtained by this method have good mechanical properties.

The invention also concerns a direct emulsion E of silicone in water comprising:
A) a silicone base A crosslinkable by polyaddition or polycondensation;
B) at least one nonionic silicone surfactant B having a cloud point comprised between 10 and 50° C., preferably between 15 and 45° C.;
C) optionally, at least one catalyst C; and
D) water.

The invention further relates to a porous silicone material obtained by heating this emulsion F to a temperature greater than or equal to 60° C.

The invention also relates to a porous silicone material comprising at least one nonionic silicone surfactant B having a cloud point comprised between 10 and 50° C., preferably between 15 and 45° C.

Finally, an object of the invention is support coated with a porous silicone material.

### DETAILED DESCRIPTION OF THE INVENTION

### Definitions

“Implementing a direct emulsion of silicone in water” is understood to mean the use of a direct emulsion E of silicone in water. This emulsion E may be prepared according to methods known to those skilled in the art, for example according to the methods described in document WO94/09058. Advantageously, the emulsion E is prepared by mixing the various components by stirring, for example with a homogenizer. It is possible to prepare the emulsion E as follows:
1. mixing the silicone base A, crosslinkable by polyaddition, with the surfactant B,
2. adding water D, and
3. adding the catalyst C.

The catalyst C may be emulsified beforehand in water.

“Porous silicone material” is understood to mean a silicone-based material containing cavities (or pores) filled with one or more gases. Porous silicone materials include silicone foams as well as elastomeric silicone foams. The porous silicone material has a lower density than the corresponding non-porous silicone material.

“Emulsion” is understood to mean a mixture of at least two immiscible liquids in which at least one of the liquids is present in the form of droplets dispersed in at least one other liquid. In the case of a direct emulsion of silicone in water, it is the silicone phase which is dispersed in the form of droplets in the water. Direct emulsions are also known by the name oil-in-water emulsion, In the case of an invert silicone emulsion, it is the water which is dispersed in the form of droplets in the silicone phase. Invert emulsions are also known by the name water-in-oil emulsion.

“Nonionic silicone surfactant” is understood to mean a nonionic surfactant comprising at least one polysiloxane chain.

“Nonionic surfactant” is understood to mean a surfactant comprising no net charge.

“Polysiloxane” is understood to mean a compound having several repeat its.

“Alkenyl” is understood to mean an unsaturated, linear or branched, substituted or unsubstituted hydrocarbon chain having, at least one olefinic double bond, and more preferably a single double bond Preferably, the “alkenyl” group has from 2 to 8 carbon atoms, more preferably from 2 to 6. This hydrocarbon chain optionally comprises at least one heteroatom such as O, N, S. Preferred examples of “alkenyl” groups are vinyl, allyl, and homoallyl groups, vinyl being particularly preferred.

“Alkynyl” is understood to mean an unsaturated, linear or branched, substituted or unsubstituted, hydrocarbon chain having at least one triple bond and more preferably a single triple bond. Preferably, the “alkynyl” group has from 2 to 8 carbon atoms, more preferably from 2 to 6. This hydrocarbon chain optionally comprises at least one heteroatom such as O, N, S.

“Alkyl” is understood to mean a linear or branched hydrocarbon chain comprising from 1 to 40 carbon atoms, preferably from 1 to 20 carbon atoms, more preferably from 1 to 10 carbon atoms. An alkyl group may be selected from the group consisting of methyl, ethyl, isopropyl, n-propyl, tert-butyl, isobutyl, n-butyl, n-pentyl isoamyl, and 1,1-dimethylpropyl.

“Cycloalkyl” according to the invention is understood to mean a monocyclic or polycyclic saturated hydrocarbon group, preferably monocyclic or bicyclic, containing from 3 to 20 carbon atoms, preferably from 5 to 6 carbon atoms. When the cycloalkyl group is polycyclic, the multiple cyclic rings may be attached to each other by a covalent bond and/or by a spiro atom and/or may be fused to each other. A cycloalkyl group may be selected from the group consisting of cyclopropyl, cyclobutyl cyclopentyl, cyclohexyl, cycloheptyl cyclooctyl, adamantane, and norbornane.

“Aryl” according to the invention is understood to mean an aromatic hydrocarbon group containing from 5 to 18 carbon atoms, monocyclic or polycyclic. An aryl group may be selected from the group consisting of phenyl, naphthyl, anthracenyl, and phenanthtyl.

“Halogen atom” according to the invention is understood to mean an atom selected from the group consisting of fluorine, chlorine, bromine, and iodine.

“Alkoxy” according to the invention is understood to mean an alkyl group as defined above, bonded to an oxygen atom. An alkoxy group may be selected from the group consisting of methoxy, ethoxy, propoxy and butoxy.

### Method for Producing a Porous Silicone Material.

The invention relates firstly to a method for producing a porous silicone material comprising the following steps:
1) implementing a direct emulsion E of silicone in water comprising:
   A) a silicone base A crosslinkable by polyaddition or polycondensation;
   B) at least one nonionic silicone surfactant B haying a cloud point comprised between 10 and 50° C., preferably between 15 and 45° C.;
   C) optionally, at least one catalyst and
   D) water;
2) heating the emulsion E to a temperature greater than or equal to 60° C. to obtain a porous silicone material; and
3) optionally, drying the porous silicone material, preferably by heating

### Direct Emulsion of Silicone in Water

The method according to the invention makes use of a direct emulsion E of silicone in water comprising:
A) a silicone base A crosslinkable by polyaddition or polycondensation;
B) at least one nonionic silicone surfactant B having a cloud point comprised between 10 and 50° C., preferably between 15 and 45° C.;
C) optionally, at least one catalyst C.; and
D) water.

Silicone Base A

The method according to the invention makes use of a direct emulsion E of silicone in water comprising a silicone base A crosslinkable by polyaddition or polycondensation.

According to a first embodiment, the silicone base A is crosslinkable by polyaddition. Silicone bases crosslinkable by polyaddition are well known to those skilled in the art; these are silicone bases which can be crosslinked by hydrosilylation reaction. In this first embodiment, the silicone base A comprises
at least one organopolysiloxane A1 comprising, per molecule, at least 2 alkenyl or alkynyl groups, linear or branched, having from 2 to 6 carbon atoms, and
at least one organohydrogenpolysiloxane A2 comprising, per molecule, at least 2 sill hydride functions Si—H.

Advantageously, the organopolysiloxane A1 is chosen from the organopolysiloxane compounds comprising repeat units of formula (I):

ZₐU_{b}SiO_{(4-(a+b)/2} (I)

in which:
the Z radicals, Which are identical or different, represent an alkenyl or alkynyl radical, linear or branched, having from 2 to 6 carbon atoms;
the U radicals, which are identical or different, represent a hydrocarbon radical having from 1 to 1.2 carbon atoms,
a=1 or 2, b≤0, 1, or 2, and a+b=1, 2, or 3;
   and optionally comprising other repeat units of formula (II):

U_{c}SiO_{(4-c)/2} (II)

where U has the same meaning as above, and c=0, 1, 2, or 3.

Preferably, the Z radicals, which are identical or different, represent an alkenyl radical, linear or branched, having from 2 to 6 carbon atoms, the vinyl radical being particularly preferred.

It is understood in formula (I) and formula (II) above that, it several U groups are present, they may be identical to or different from each other. In formula (I), the symbol a may preferably be equal to 1.

In formula (I) and formula (II), U may represent a monovalent radical selected from the group consisting of alkyl groups having from 1 to 8 carbon atoms, optionally substituted by at least one halogen atom such as chlorine or fluorine, cycloalkyl groups having from 3 to 8 carbon atoms, and aryl groups having from 6 to 12 carbon atoms, U may advantageously be selected from the group consisting of methyl, ethyl, propyl, 3,3,3-trifluoropropyl, xylyl, tolyl, and phenyl.

Said organopolysiloxanes A1 may be oils of dynamic viscosity on the order of 10 to 100,000 mPa·s at 25° C., generally on the order of 10 to 70,000 mPa·s at 25° C., or gums of dynamic viscosity on the order of 1,000,000 mPa·s or more at 25° C.

All the viscosities in question in this description correspond to a dynamic viscosity value at 25° C. referred to as “Newtonian”, meaning the dynamic viscosity which is measured with a Brookfield viscometer in a manner known per se, at a sufficiently low shear rate gradient that the measured viscosity is independent of the rate gradient.

These organopolysiloxanes A1 may have a linear, branched, or cyclic structure. Their degree of polymerization is preferably between 2 and 5000.

When linear polymers are concerned, they consist essentially of “D” siloxyl units selected from the group consisting of the siloxyl units Z₂SiO_{2/2}, and ZUSiO_{2/2} and U₂SiO_{2/2}, and “M” siloxyl units selected from the group consisting of the siloxyl units ZU₂SiO_{1/2}, Z₂USiO_{1/2} and Z₃SiO_{1/2}. The Z and U symbols are as described above.

Examples of terminal “M” units include trimethylsiloxy, dimethylphenylsiloxy, dimethylvinylsiloxy, or dimethylhexenylsiloxy groups.

Examples of “D” units include dimethylsiloxy, methylphenylsiloxy, methylvinylsiloxy, methylbutenylsiloxy, methylhexenylsiloxy, methyldecenylsiloxy, or methyldecadienylsiloxy groups.

Examples of linear organopolysiloxanes which can be unsaturated compounds A1 according to the invention are:
a poly(dimethylsiloxane) with dimethylvinylsilyl ends;
a poly(dimethylsiloxane-co-methylphenylsiloxane) with dimethylvinylsilyl ends;
a poly(dimethylsiloxane-co-methylyinylsiloxane) with dimethylvinylsilyl ends; and
a poly(dimethylsiloxane-co-methylvinylsiloxime) with trimethylsilyl ends and
a cyclic poly(methylvinyIsiloxane).

Cyclic organopolysiloxanes which can also be unsaturated compounds A1 according to die invention are, for example, those consisting of “D” siloxyl units of the following formulas: Z₂SiO_{2/2}, U₂SiO_{2/2} or ZUSiO_{2/2}, which may be of the dialkylsiloxy, alkylarylsiloxy, alkylvinylsiloxy, alkylsiloxy type. Said cyclic organopolysiloxanes have a viscosity on the order of 10 to 5000 mPa·s at 25° C.

Preferably, the organopolysiloxane compound A1 has a mass percent of Si-vinyl unit comprised between 0.001 and 30%, preferably between 0.01 and 10%.

Other examples of unsaturated compounds A1 include silicone resins comprising at least one vinyl radical. For example, they may be selected from the group consisting of the following silicone resins:
MD^{Vi}Q where vinyl groups are included in the D units,
MD^{Vi}TQ where vinyl groups are included in the D units,
MM^{Vi}Q where vinyl groups are included in a portion of the M units,
MM^{Vi}Q where vinyl groups are included in a portion of the M units,
MM^{Vi}DD^{Vi}Q where vinyl groups are included in a portion of the M and D units,
and mixtures thereof,
   with:
M^{Vi}=siloxyl unit of formula (R)₂(vinyl)SiO_{1/2}
D^{Vi}=Siloxyl unit of formula (R)(vinyl)SiO_{2/2}
T=siloxyl unit of formula (R)SiO_{3/2}
Q=siloxyl unit of formula SiO_{4/2}
M=siloxyl unit of formula (R)₃SiO_{1/2}
D=siloxyl unit of formula (R)₂SiO_{2/2}
   and the R functional groups, which are identical or different, are monovalent hydrocarbon groups selected from: alkyl groups having from 1 to 8 carbon atoms inclusive, such as methyl, ethyl, propyl, and 3,3,3-trifluoropropyl groups, and aryl groups such as xylyl, tolyl, and phenyl. Preferably, the R functional groups are methyls.

Of course, depending on the variants, the organopolysiloxane A1 may be a mixture of several oils or resins corresponding to the definition of organopolysiloxane A1.

The organohydrogenpolysiloxane A2 may advantageously be an organopolysiloxane comprising at least one repeat unit of formula (III):

H_{d}UₑSiO_{(4-(d+e))/2} (III)

where:
the U radicals, which are identical or different, represent a hydrocarbon radical having from 1 to 12 carbon atoms,
d=1 or 2, e=0, 1, or 2, and d+e=1, 2, or 3;
   and optionally other repeat units of formula (IV):

U_{f}SiO_{(4-f)/2} (IV)

where U has the same meaning as above, and f=0, 1, 2, or 3.

It is understood in formula (III) and formula (IV) above that, if several U groups are present, they may be identical to or different from each other. In formula (III), the symbol d preferably may be equal to 1. In addition, in formula (III) and formula (IV), U may represent a monovalent radical selected from the group consisting of: alkyl groups having 1 to 8 carbon atoms, optionally substituted by at least one halogen atom such as chlorine or fluorine, cycloalkyl groups having from 3 to 8 carbon atoms, and aryl groups having front 6 to 12 carbon atoms. U may advantageously be selected from the group consisting of methyl, ethyl, propyl, 3,3,3-trifluoropropyl, xylyl, tolyl, and phenyl.

These organopolysiloxanes A2 may have a linear, branched, or cyclic structure. The degree of polymerization is preferably greater than or equal to 2. Generally, it is less than 5000. When linear polymers are concerned, they essentially consist of:
“D” siloxyl units selected from units of the following formulas: U₂SiO_{2/2} or UHSiO_{2/2}, and
“M” siloxyl units selected from units of the following formulas: U₃SiO_{1/2} or U₂HSiO_{1/2}.

The linear organopolysiloxanes may be oils of dynamic viscosity on the order of 1 to 100,000 mPa·s at 25° C. and more generally on the order of 10 to 5,000 mPa·s at 25° C.

Examples of organopolysiloxanes able to be compounds A2 according to the invention comprising at least one hydrogen atom bonded to a silicon atom are:
a poly(dimethylsiloxane) with hydrogenodimethylsilyl ends;
a poly(dimethylsiloxane-co-methylhydrogenosiloxane) with trimethylsilyl ends;
a poly(dimethylsiloxane-co-methylhydrogenosiloxane) with hydrogenodimethylsilyl ends;
a poly(methylhydrogenosiloxane) with trimethylsilyl ends; and
a cyclic poly(methylhydrogenosiloxane).

When cyclic organopolysiloxanes are concerned, they consist of “D” siloxyl units of the following formulas: U₂SiO_{2/2} and UHSiO_{2/2}, which may be of the dialkylsiloxy or alkylarylsiloxy type or of UHSiO_{2/2} units only, They then have a viscosity on the order of 1 to 5000 mPa·s.

Compound A2 is an organohydrogenpolysiloxane compound comprising, per molecule, at least two and preferably at least three silyl hydride functions (Si—H).

The following compounds are particularly suitable for the invention as organohydrogenpolysiloxane compounds A2:

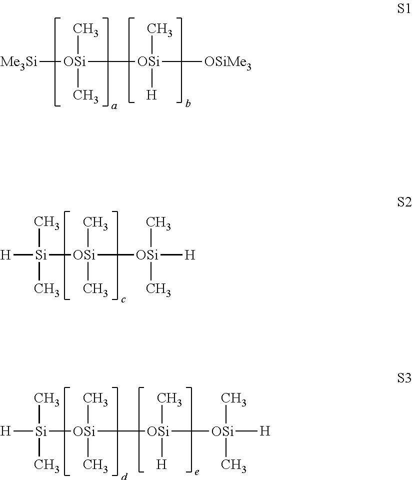

with a, b, c, d, and e defined below:
in the polymer of formula S1:
   0≤a≤150, preferably 0≤a≤100, and more particularly 0≤a≤20, and
   1≤b≤90, preferably 10≤b≤80, and more particularly 30≤b≤70,
in the polymer of formula S2: 0≤c≤15
in the polymer of formula S3: 5≤d≤200, preferably 20≤d≤100; and 2≤e≤90, preferably 10≤e≤70.

In particular, an organohydrogenpolysiloxane compound A2 suitable for the invention is the compound of formula S1, where a=0.

Preferably, the organohydrogenpolysiloxane compound A2 has a mass percent of silyl hydride functions Si—H comprised between 0.2 and 91%. The organohydrogenpolysiloxane compound A2 may have a mass percent of silyl hydride functions Si—H greater than or equal to 15%, preferably greater than or equal to 30%. For example, the mass percent of silyl hydride functions Si—H is comprised between 15 and 90%, or between 30 and 85%,

According to one embodiment, the organohydrogenpolysiloxane A2 is a resin having a branched structure. The organohydrogenpolysiloxane A2 may be selected from the group consisting of the following silicone resins:
M′Q where the hydrogen atoms bonded to silicon atoms are carried by the M groups,
MM′Q where the hydrogen atoms bonded to silicon atoms are carried by a portion of the M units,
MD′Q where the hydrogen atoms bonded to silicon atoms are carried by the D groups,
MDD′Q where the hydrogen atoms bonded to silicon atoms are carried by a portion of the D groups,
MM′TQ where the hydrogen atoms are included M a portion of the M units,
MM′DD′Q where the hydrogen atoms are included in a portion of the M and D units.
and mixtures thereof,
   with:
M, D, T and Q as defined previously
M′=siloxyl unit of formula R₂HSiO_{1/2}
D′=siloxyl unit of formula RHSiO_{2/2}
and the R functional groups, which are identical or different, are monovalent hydrocarbon groups selected from the alkyl groups having from 1 to 8 carbon atoms inclusive, such as the methyl, ethyl, propyl, and 3,3,3-trifluoropropyl groups. Preferably, the R functional groups are methyls.

Preferably, the organohydrogenpolysiloxane resin A2 is an M′Q or MD′Q resin as described above. Even more preferably, the organohydrogenpolysiloxane resin A2 is an M′Q resin.

Of course, depending on the variants, the organohydrogenpolysiloxane A2 may be a mixture of several oils or resins corresponding to the definition of organohydrogenpolysiloxane A2.

Advantageously, the molar ratio of the silyl hydride functions Si—H of compounds A2 to the alkene and alkyne functions of compounds A1 is comprised between 0.02 and 5, preferably between 0.1 and 4, and more preferably between 0.5 and 3.

According to a second embodiment, the silicone base A is crosslinkable by polycondensation. The silicone bases crosslinkable by polycondensation are well known to those skilled in the art. In this second embodiment, the silicone base A comprises
at least one organopolysiloxane A3 comprising at least two OH functional groups or at least two hydrolyzable functional groups, and
optionally, at least one crosslinking agent A4.

Preferably, the organopolysiloxane A3 carries at least two functional groups chosen from the group consisting of the hydroxy, alkoxy-alkylene-oxy, amino, amido, acylamino, aminoxy, iminoxy, ketiminoxy, acyloxy, and enoxy functional groups.

Advantageously, the organopolysiloxane A3 comprises:
(i) at least two siloxyl units of the following formula (V):

$${R}_{g}^{1} {Y}_{h} {SiO}_{\frac{4 - ( g + h )}{2}} \qquad ( V )$$

in which:
the R¹ radicals, which are identical or different, represent monovalent C₁ to C₃₀ hydrocarbon radicals,
the Y radicals, which are identical or different, each represent a hydrolyzable and condensable functional group or a hydroxy functional group, and are preferably selected from the group consisting of the hydroxy, alkoxy, alkoxy-alkylene-oxy, amino, amido, acylamino, aminoxy, iminoxy, ketiminoxy, acyloxy, and enoxy functional groups,
g is equal to 0, 1, or 2, h is equal to 1, 2, or 3, the sum g+h is equal to 1, 2, or 3, and (
ii) optionally one or more siloxyl unit(s) of the following formula (VI):

$${R}_{i}^{2} {SiO}_{\frac{4 - i}{2}} \qquad ( VI )$$

in which:
the R² radicals, which are identical or different, represent monovalent C₁ to C₃₀ hydrocarbon radicals optionally substituted by one or more halogen atoms or by amino, ether, ester, epoxy, mercapto, or cyano functional groups, and
the symbol i is equal to 0, 1, 2, or 3.

Examples of hydrolyzable and condensable functional groups Y of the alkoxy type include groups having from 1 to 8 carbon atoms such as the methoxy, ethoxy, n-propoxy, iso-propoxy, n-butoxy iso-butoxy, sec-butoxy, tert-butoxy 2-methoxyethoxy, hexyloxy, or octyloxy groups.

Examples of hydrolyzable and condensable functional groups Y of the alkoxy-akylene-oxy type include the methoxy-ethylene-oxy functional group.

Examples of hydrolyzable and condensable functional groups Y of the amino type include the methylamino, dimethylamino, ethylamino, diethylamino, n-butylamino, sec-butylamino, or cyclohexylamino functional groups.

Examples of hydrolyzable and condensable functional groups Y of the amido type include the N-methyl-acetamido functional group.

Examples of hydrolyzable and condensable functional groups Y of the acylamino type include the benzoyl-amino functional group.

Examples of hydrolyzable and condensable functional groups Y of the aminoxy type include the dimethylaminoxy, diethylaminoxy, dioctylaminoxy, or diphenylaminoxy functional groups.

Examples of hydrolyzable and condensable functional groups Y of the iminoxy and in particular of the ketiminoxy type include the functional groups derived from the following oximes: acetophenone-oxime, acetone-oxime, benzophenone-oxime, methyl-ethyl-ketoxime, di-isopropylketoxime, or methylisobutyl-ketoxime.

Examples of hydrolyzable and condensable functional groups Y of the acyloxy type include the acetoxy functional group.

Examples of hydrolyzable and condensable functional groups Y of the enoxy type include the 2-propenoxy functional group.

The viscosity of the organopolysiloxane A3 is generally between 50 mPa·s and 1,000,000 mPa·s at 25° C.

Preferably, the organopolysiloxane A3 has the general formula (VII):

YⱼR³₃₋ⱼSi—O—(SiR³₂—O)ₚ—SiR³₃₋ⱼYⱼ (VII)

in which:
the Y radicals, which are identical or different, each represent a hydrolyzable and condensable functional group or a hydroxy functional group, and are preferably selected from the group consisting of the hydroxy, alkoxy, alkoxy-alkylene-oxy, amino, amido, acylamino, aminoxy, iminoxy, ketiminoxy, acyloxy, and enoxy functional groups,
the R³ radicals, which are identical or different, represent monovalent C₁ to C₃₀ hydrocarbon radicals optionally substituted by one or more halogen atoms or by amino, ether, ester, epoxy, mercapto, cyano functional groups,
the symbol j is equal to 1, 2, or 3, preferably equal to 2 or 3, and when Y is a hydroxyl group then j≤1, and
p is an integer greater than or equal to 1, preferably p is an integer comprised between 1 and 2000.

In formulas (V), (VI) and (VII), the R¹, R² and R³ radicals are preferably:
alkyl radicals having from 1 to 20 carbon atoms, optionally substituted by one or more aryl or cycloalkyl groups, by one or more halogen atoms, or by amino, ether, ester, epoxy, mercapto, cyano, or (poly)glycol functional groups. Examples include the radicals: methyl, ethyl, propyl, isopropyl, butyl, pentyl, hexyl, 2-ethylhexyl, octyl, decyl, 3,3,3-trifluoropropyl, 4,4,4-trifluorobutyl, 4,4,4,3,3-pentafluorobutyl; cycloalkyl and halogenocycloalkyl radicals having from 5 to 13 carbon atoms such as the radicals: cyclopentyl, cyclohexyl, methylcyclohexyl, propylcyclohexyl, 2,3-difluoro-cyclobutyl 3,4-difluoro-5-methyl-cycloheptyl;
mononuclear aryl and haloaryl radicals having from 6 to 13 carbon atoms such as the radicals: phenyl, tolyl, xylyl, chlorophenyl dichlorophenyl trichlorophenyl; or
alkenyl radicals having from 2 to 8 carbon atoms such as the radicals: vinyl, allyl, and butene-2-yl.

In the particular case where the organopolysiloxane A3 is an organopolysiloxane of general formula (VII) with Y symbols of the hydroxyl type, then the j symbol will preferably be equal to 1. In this case, it is preferred to use poly(dimethylsiloxane) having silanol functions at the terminal positions (also called “alpha-omega” positions).

The organopolysiloxane A3 may also be selected from the organosilicon resins bearing at least one hydroxy or alkoxy group, functional groups which are either condensable or condensable or hydrolyzable, which comprise at least two different siloxyl units selected from those of formula M, D, T, and Q with:
the siloxyl unit M=(R⁰)₃SiO_{1/2},
the siloxyl unit D=(R⁰)₂SiO_{2/2},
the siloxyl unit T=R⁰SiO_{3/2}, and
the siloxyl unit Q=SiO_{4/2};
   formulas in which R⁰ represents a monovalent hydrocarbon functional group having from 1 to 40 carbon atoms and preferably from 1 to 20 carbon atoms, or an OR′″ group where R′″=H or an alkyl radical having from 1 to 40 carbon atoms and preferably from 1 to 20 carbon atoms;
   with the condition that the resins comprise at least one T or Q unit.

Said resin preferably has a weight percent of hydroxy or alkoxy substituents that is comprised between 0.1 and 10% by weight relative to the weight of the resin, and preferably a weight percent of hydroxy or alkoxy substituents that is comprised between 0.2 and 5% by weight relative to the weight of the resin.

Organosilicon resins generally have about 0.001 to 1.5 OH and/or alkoxyl groups per silicon atom. These organosilicon resins are generally prepared by co-hydrolysis and co-condensation of chlorosilanes such as those having the formulas (R¹⁹)₃SiCl, (R¹⁹)₂Si(Cl)₂, R¹⁹Si(Cl)₃, or Si(Cl)₄, the R¹⁹ radicals being identical or different and generally selected from linear or branched C₁ to C₆ alkyl, phenyl, and 3,3,3-trifluoropropyl radicals. Examples of R¹⁹ radicals of the alkyl type include in particular a methyl, an ethyl, an isopropyl, a tert-butyl, and an n-hexyl.

Examples of a resin include silicone resins of the following types: T^{(OH)}, DT^{(OH)}, DQ^{(OH)}, DT^{(OH)}, MQ^{(OH)}, MDT^{(OH)}, MDQ^{(OH)}, or mixtures thereof.

In this second embodiment, the silicone base may further contain a crosslinking agent A4. The crosslinking agent is preferably an organosilicon compound bearing more than two hydrolyzable groups bonded to the silicon atoms, per molecule. Such crosslinking agents are well known to those skilled in the art and are commercially available. The crosslinking agent A4 is preferably a silicon-based compound in which each molecule comprises at least three hydrolyzable and condensable functional groups Y, said crosslinking agent A4 having the following formula (VIII):

R⁴₍₄₋ₖ₎SiYₖ (VIII)

in which:
the R⁴ radicals, which are identical or different, represent monovalent C₁ to C₃₀ hydrocarbon radicals,
the Y radicals, which are identical or different, are selected from the group consisting of the alkoxy, alkoxy-alkylene-oxy amino, amido, acylamino, aminoxy, iminoxy, ketiminoxy, acyloxy, or enoxy functional groups, and preferably Y is an alkoxy, acyloxy, enoxy, ketiminoxy or oxime functional group, and
the symbol k=2, 3, or 4, and preferably k=3 or 4.

Examples of Y functional groups are the same as those mentioned above when the symbol is a hydrolyzable and condensable functional group, in other words different from a hydroxyl functional group.

Other examples of a crosslinking agent A4 include alkoxysilanes and the products of partial hydrolysis of this silane of the following general formula (IX);

R⁵₁Si(OR⁶)₍₄₋ₗ₎ (IX)

in which:
the R⁵ radicals, which are identical or different, represent alkyl radicals having from 1 to 8 carbon atoms, such as the methyl, ethyl, propyl, butyl, pentyl, 2-ethylhexyl, octyl, and decyl radicals, C₃-C₆oxyalkylene radicals,
the R radicals, which are identical or different, represent a saturated or unsaturated, linear or branched, aliphatic hydrocarbon group, a group that is carbocyclic, saturated or unsaturated and/or aromatic, monocyclic or polycyclic, and
l is equal to 0, 1, or 2.

Among the crosslinking agents A4, particularly preferred are the alkoxysilanes, ketiminoxysilanes, alkyl silicates and alkyl polysilicates, in which the organic radicals are alkyl radicals having from 1 to 4 carbon atoms.

Preferably, the following crosslinking agents A4 are used, alone or in combination;
ethyl polysilicate and n-propyl polysilicate;
alkoxysilanes such as dialkoxysilanes, for example dialkyldialkoxysilanes, trialkoxysilanes, for example alkyltrialkoxysilanes, and tetraalkoxysilanes, and preferably propyltrimethoxysilane, methyltrimethoxysilane, methyltriethyoxysilane, ethyltrimethoxysilane, ethyltriethoxysilane, isobutyltrimethoxysilane, isobutyltriethoxysilane, propyltriethoxysilane, tetramethoxysilane, tetraethoxysilane, tetrapropoxysilane, tetrabutoxysilane, 1,2-bis(trimethoxysilyl)ethane, 1,2-bis(triethoxysilyl)ethane, tetraisopropoxysilane, phenyltriethoxysilane, phenyltrimethoxysilane, vinyltriethoxysilane, vinyltrimethoxysilane, and those of the following formulas: [CH₃][OCH(CH₃)CH₂OCH₃]Si[OCH₃]₂, Si(OC₂H₄OCH₃)₄ and CH₃Si(OC₂H₄OCH₃)₃,
acyloxysilanes such as the following acetoxysilanes: tetraacetoxysilane, methyltriacetoxysilane, ethyltriacetoxysilane, vinyltriacetoxysilane, propyltriacetoxysilane, butyltriacetoxysilane, phenyltriacetoxysilane, octyltriacetoxysilane, dimethyldiacetoxysilane, phenylmethyldiacetoxysilane, vinylmethyldiacetoxysilane, diphenyldiacetoxysilane, and tetraacetoxysilane,
silanes comprising alkoxy and acetoxy functional groups such as: methyl-diacetoxymethoxysilane, methylacetoxydimethoxysilane, vinyldiacetoxymethoxysilane, vinylacetoxydimethoxysilane, methyldiacetoxyethoxysilane, and methylacetoxydiethoxysilane,
methyltris(methylethyl-ketoximo)silane, 3-cyanopropyltrimethoxysilane, 3-cyanopropyl-triethoxysilane, 3-(glycidyloxy)propyltriethoxysilane, vinyltris (methylethylketoximo)silane tetrakis(methylethylketoximo)silane.

Generally 0.1 to 60 parts by weight of crosslinking agent A4 per 100 parts by weight of organopolysiloxane A3 are used. Preferably, 0.5 to 15 parts by weight are used per 100 parts by weight of the organopolysiloxane A3.

In the above two embodiments, the silicone base A may also comprise functional additives that are conventional in silicone compositions. Families of conventional functional additives include:
adhesion promoters;
hydrosilylation reaction inhibitors or retarders;
silicone resins;
pigments; and
additives for heat resistance, oil resistance, or fire resistance, for example metal oxides.

The fillers optionally provided are preferably minerals. They may in particular be siliceous. Siliceous materials can act as reinforcing or semi-reinforcing filler, Reinforcing siliceous fillers are selected from colloidal silicas, combustion and precipitated silica powders, or mixtures thereof. These powders have an average particle size that is generally less than 0.1 μm (micrometers) and a BET specific surface area greater than 30 m²/g, preferably between 30 and 350 m²/g. Semi-reinforcing siliceous fillers such as diatomaceous earth or crushed quartz may also be used. For non-siliceous mineral materials, these can serve as semi-reinforcing mineral filler. Examples of these non-siliceous fillers which can be used alone or in combination are carbon black, titanium dioxide, aluminum oxide, hydrated alumina, expanded vermiculite, unexpanded vermiculite, calcium carbonate optionally surface treated by fatty acids, zinc oxide, mica, talc, iron oxide, barium sulfate, and slaked lime. These fillers have a particle size generally comprised between 0.001 and 300 μm (micrometers) and a BET surface area of less than 100 m/g. In practice, but this is non-limiting, the fillers used may be a mixture of quartz and silica. The fillers may be treated with any suitable product. Concerning the weight, it is preferred to use an amount of filler comprised between 1% and 50% by weight, preferably between 2% and 40% by weight, relative to all constituent elements of the silicon base A.

Adhesion promoters are widely used in silicone compositions. Advantageously, in the method according to the invention, one or more adhesion promoters may be used, selected from the group consisting of:
alkoxylated organosilanes containing, per molecule, at least one C₂-C₆ alkenyl group selected from products of the following general formula (D1):

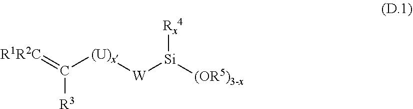

a formula in which:
R¹, R², R³ are hydrogen or hydrocarbon radicals which are identical to or different from one another and represent a hydrogen atom, a linear or branched C₁-C₄ alkyl, or a phenyl optionally substituted by at least one C₁-C₃ alkyl,
U is a linear or branched C₁-C₄ alkylene,
W is a valence bond,
R⁴ and R⁵ are identical or different radicals and represent a linear or branched C₁-C₄ alkyl,
x′=0 or 1, and
x=0 to 2,
organosilicon compounds comprising at least one epoxy radical, selected from:
   a) products (D.2a) corresponding to the following general formula:

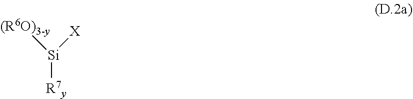

a formula in which:
R⁶ is a linear or branched C₁-C₄ alkyl radical,
R⁷ is a linear or branched C₁-C₄ alkyl radical,
y is equal to 0, 1, 2, or 3, and
X being defined by the following formula:

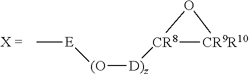

with:
E and D which are identical or different radicals selected from the linear or branched C₁-C₄ alkyls,
z which is equal to 0 or 1,
R⁸, R⁹, R¹⁰ which are identical or different radicals representing a hydrogen atom or a linear or branched C₁-C₄ alkyl, and
R⁸ and R⁹ or R¹⁰ possibly in alternation forming, together and with the two carbons carrying the epoxy, an alkyl ring having 5 to 7 members, or
   b) the products (D.2b) composed of epoxyfunctional polydiorganosiloxanes comprising:
      (i) at least one siloxyl unit of formula (D.2 bi):

$${X}_{p} {G}_{q} SiO \frac{4 - ( p + q )}{2} \qquad ( D .2 bi )$$

a formula in which:
X is the radical as defined above for formula (D.2 a)
G is a monovalent hydrocarbon group selected from alkyl groups having from 1 to 8 carbon atoms inclusive, optionally substituted by at least one halogen atom, and from aryl groups containing between 6 and 12 carbon atoms,
p=1 or 2,
q=0, 1, or 2,
p+q=1, 2, or 3, and
   and (ii) optionally at least one siloxyl unit of formula (D.2 bii):

$${G}_{r} SiO \frac{4 - r}{2} \qquad ( D .2 bii )$$

a formula in which:
G has the same meaning as above, and
r is equal to 0, 1, 2, or 3.
organosilicon compounds comprising at least one silyl hydride function and at least one epoxy radical, and
metal chelates M and/or metal alkoxides of the general formula:

M(OJ)ₙ,

in which
M is selected from the group formed by: Ti, Zr, Ge, Li, Mn, Fe, Al, and Mg, or mixtures thereof
n=valency of M and J=linear or branched C₁-C₈ alkyl.

Preferably M is chosen from the following list: Ti, Zr, Ge, Li or Mn, and even more preferably the metal M is titanium. It may be associated, for example, with an alkoxy radical of the butoxy type.

Silicone resins are well known and commercially available branched organopolysiloxane oligomers or polymers. In their structure, they have at least two different repeat units selected from those of formula R₃SiO_{1/2} (unit M), R₂SiO_{2/2} (unit D), RSiO_{3/2} (unit T), and SiO_{4/2} (unit Q), at least one of these units being a T or Q unit. The R radicals are identical or different and are selected from the radicals: linear or branched C₁-C₆ alkyl, hydroxyl, phenyl, 3,3,3-trifluoropropyl. Examples of alkyl radicals include methyl, ethyl, isopropyl, tert-butyl, and n-hexyl radicals.

Examples of branched oligomers or organopolysiloxane polymers include MQ resins, MDQ resins, TD resins, and MDT resins, the hydroxyl functions possibly being carried by the M, D, and/or T units. Examples of particularly suitable resins are hydroxylated MDQ resins having a weight percent of hydroxyl group comprised between 0.2 and 10% by weight.

### Nonionic Silicone Surfactant B

The direct emulsion E of silicone in water comprises a nonionic silicone surfactant B having a cloud point comprised between 10 and 50° C. preferably between 15 and 45° C. The cloud point of the nonionic silicone surfactant B may be comprised between 16 and 43° C.

The concept of cloud point of a nonionic surfactant is well known to those skilled in the art. Indeed, it is established in the literature that the solubility of nonionic surfactants in water decreases with the temperature. From a certain temperature, an aqueous solution of a nonionic surfactant becomes more opaque and turns cloudy, because the solubility of the surfactant is too low.

The cloud point of a nonionic surfactant is the temperature above which an aqueous solution of surfactant becomes more opaque and cloudy. Advantageously, the cloud point is measured for an aqueous solution at 1% by mass of surfactant in water.

The cloud point of the surfactant can be determined by the following test: the surfactant is introduced at a concentration of 1% by mass in distilled water, with constant stirring and with the temperature controlled by a heating plate. If the solution is clear at room temperature, the mixture is heated until complete opacity is obtained, then it is cooled slowly and the temperature at which the opacity disappears is determined. In the case where the solution is already opaque or cloudy at room temperature, it is cooled, and the temperature at which the opacity disappears is similarly determined. This opacity, disappearance temperature is the cloud point or cloud temperature of the surfactant.

Advantageously, the nonionic silicone surfactant B is an organopolysiloxane polyoxyalkylene copolymer. These copolymers are also known by the name organopolysiloxane-polyether copolymers. Preferably, the organopolysiloxane-polyoxyalkylene copolymer B comprises siloxyl units having sequences of ethylene oxide chains, and optionally sequences of propylene oxide chains.

Preferably, the organopolysiloxane-polyoxyalkylene copolymer B comprises siloxyl units of formula (B1)

[R¹ₐZ_{b}SiO_{(4-a-b)/2}]ₙ (B-1)

in which
the R¹ radicals, which are identical or different, represent a hydrocarbon radical having from 1 to 30 carbon atoms, preferably selected from the alkyl groups having from 1 to 8 carbon atoms and the aryl groups having from 6 to 12 carbon atoms;
n is an integer greater than or equal to 2;
a and b are independently 0, 1, 2, or 3, and a+b=0, 1, 2, or 3;
each Z radical is a —R²—(OCₚH₂ₚ)_{q}(OC_{f}H₂ᵣ)₈—OR³ group,
where
   R² is a divalent hydrocarbon group having from 2 to 20 carbon atoms, or a bond;
   R³ is H or an R¹ group as defined above,
   p and r are, independently, an integer between 1 and 6;
   q and s are, independently, 0 or an integer such that 1<q+s<400;
      and each molecule of organopolysiloxane-polyoxyalkylene copolymer B comprises at least one Z group.

In a preferred embodiment, the organopolysiloxane-polyoxyalkylene copolymer B comprises repeat units of formula (B-1) above in which
n is an integer greater than or equal to 2;
a and b are independently 0, 1, 2, or 3, and a+b=0, 1, 2, or 3;
the R¹ radicals, which are identical or different, represent an alkyl group having from 1 to 8 carbon atoms inclusive, and more preferably R¹ is a methyl group;
   R² is a divalent hydrocarbon group having from 2 to 6 carbon atoms or a bond;
   R³ is H or an alkyl group having, from 1 to 8 carbon atoms inclusive, preferably R³ is H
   p=2 and r=3
   q is comprised between 1 and 40, preferably between 5 and 30
   s is comprised between 1 and 40, preferably between 5 and 30
      and each molecule of organopolysiloxane-polyoxyalkylene copolymer B comprises at least one Z group.

Advantageously, the organopolysiloxane-polyoxyalkylene copolymer B comprises repeat units of formula (B-1) above in which b=0 or 1.

According to one embodiment, B is an organopolysiloxane having a total number of siloxyl units of formula (B-1) comprised between 1 and 200, preferably between 50 and 150, and a total number of Z groups comprised between 2 and 25, preferably between 3 and 15.

An example of an organopolysiloxane-polyoxyalkylene copolymer B which may be used in the present method corresponds to formula (B-2)

R^{a}₃SiO[R₂^{a}SiO]ₜ[R^{a}Si(R^{b}—(OCH₂CH₂)ₓ(OCH₂CH₂CH₂)_{y}—OH)O]_{f}SiR^{a}₃ (B-2)

in which
each R^{a} is independently selected from the alkyl groups having from 1 to 8 carbon atoms inclusive, preferably R^{a} is methyl;
each R^{b} is a divalent hydrocarbon group having from 2 to 6 carbon atoms, or a bond, preferably R^{b} is a propyl group;
x and y are, independently, integers between 1 and 40, preferably between 5 and 30, and more preferably between 10 and 30,
t is comprised between 1 and 200, preferably between 25 and 150, and
r is comprised between 2 and 25, preferably between 3 and 15.

The methods for preparing organopolysiloxane-polyoxyalkylene copolymers B are well known to those skilled in the art. For example, an organopolysilexane-polyoxyalkylene copolymer can be prepared by hydrosilylation, for example by reacting a polydiorganosiloxane comprising an Si—H bond with a polyoxyalkylene comprising groups having aliphatic unsaturations, in the presence of a platinum catalyst.

According to one particular embodiment, the organopolysiloxane-polyoxyalkylene copolymer B is selected from
compounds of formula (B-3):

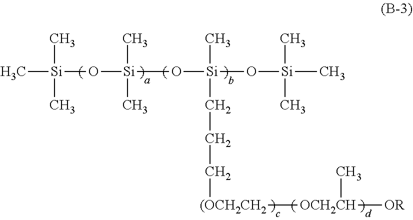

where
   0≤a≤100; 1≤b≤100; 0≤c≤100; 0≤d≤100 and c+d≥1;
   R is H or an alkyl group having from 1 to 6 carbon atoms inclusive
polyether silicones of formula (B-4)

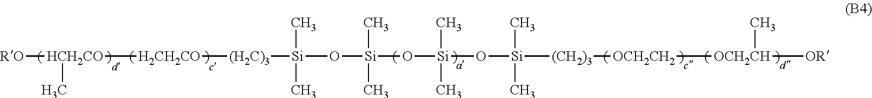

where
   0≤a′≤100; 0≤c′≤100; 0≤d′≤100; 0≤c″≤100; 0≤d″≤100;
   each R′ is, independently, H or an alkyl group having from 1 to 6 carbon atoms inclusive
and mixtures thereof.

The amount of nonionic silicone surfactant B is comprised between 0.1 and 70% relative to the total mass of silicone base contained in the emulsion, preferably between 0.5 and 50%, more preferably between 1 and 25%, and even more preferably between 2 and 20%.

Catalyst C

The direct emulsion E of silicone in water may also comprise a catalyst C. This catalyst is used to catalyze the polyaddition or polycondensation reaction of the silicone base A.

In the first embodiment, where the silicone base A is a base crosslinkable by polyaddition, the catalyst C is a hydrosilylation reaction catalyst. These catalysts are well known. Platinum and rhodium compounds are preferably used. In particular, one can use the complexes of platinum and of an organic product described in patents U.S. Pat. Nos. 3,159,601, 3,159,602, 3,220,972 and European patents EP-A-0,057,459, EP-A-0,188,978 and EP-A-0,190,530, and the complexes of platinum and of vinylated organosilosanes described in U.S. Pat. Nos. 3,419,593, 3,715,334, 3,377,432, and 3,814,730. The generally preferred catalyst is platinum, In this case, the quantity by weight of the catalyst C, calculated by weight of the platinum-metal, is generally between 2 and 400 ppm, preferably between 5 and 200 ppm based on the total weight of the organopolysiloxanes A1 and A2. In this case, the catalyst C may be a platinum catalyst, for example a Karstedt's catalyst.

In the second embodiment, where the silicone base A is a base crosslinkable by polycondensation, the catalyst C is a condensation reaction catalyst. Without placing limitations, the polycondensation catalyst could be chosen for example from metal complexes or chelates based on tin or titanium which are widely known to those skilled in the art, or from organic catalysts such as the amines or guanidines described in patent applications EP2268743 and EP2367867, or from metal complexes for example based on Zn, Mo, Mg, etc. described in patent applications EP2222626, EP2222756, EP2222773, EP2935489, EP2935490, and WO2015/082837.

Water D

The direct emulsion E of silicone in water comprises water,. Advantageously, the emulsion comprises between 10 and 80% water by mass relative to the total mass of the emulsion, preferably between 30 and 75%, and even more preferably between 35 and 65%. According to one specific embodiment, the emulsion comprises more than 50% water by mass relative to the total mass of the emulsion. The emulsion may comprise between 50.5 and 80% water by mass relative to the total mass of the emulsion, preferably between 51 and 75%, and even more preferably between 52 and 65%.

Thickener F

The direct emulsion E of silicone in water may also comprise a thickener F. The thickener F may be selected from different types of thickeners, including organic thickeners, inorganic thickeners, natural thickeners, and synthetic thickeners. The thickener F may be selected from thickeners based on natural gum, for example such as xanthan-type gums and succinoglycan gums. The thickener F may also be selected from cellulose fibers.

The thickener F makes it possible to change the viscosity of the emulsion. Those skilled in the art will know how to adapt the amount of thickener for the desired viscosity. Advantageously, the amount of thickener in the emulsion E is comprised between 0.01 and 30% by mass relative to the mass of the silicone base A, between 0.1 and 20% by mass, or between 0.5 and 10% by mass.

According to a preferred embodiment of the method according to the invention, the direct emulsion E of silicone in water comprises
A) a silicone base A crosslinkable by polyaddition, comprising
   at least one organopolysiloxane A1 comprising, per molecule, at least 2 alkenyl or alkynyl groups, linear or branched, having from 2 to 6 carbon atoms, and
   at least one organohydrogenpolysiloxane A2 comprising, per molecule, at least 2 silyl hydride functions Si—H
B) at least one nonionic silicone surfactant B haying a cloud point comprised between 10 and 50° C., preferably between 15 and 45° C.;
C) optionally, at least one catalyst C; and
D) water.

According to a particularly preferred embodiment of the method according to the invention, the direct emulsion E of silicone in water comprises
A) a silicone base A crosslinkable by polyaddition, comprising
   at least one organopolysiloxane A1 comprising, per molecule, at least 2 alkenyl or alkynyl groups, linear or branched, having, from 2 to 6 carbon atoms, and
   at least one organohydrogenpolysiloxane A2 comprising, per molecule, at least 2 silyl hydride functions Si—H
B) at least one nonionic silicone surfactant B selected from the organopolysiloxanepolyoxyalkylene copolymers having a cloud point comprised between 10 and 50° C., preferably between 15 and 45° C.;
C) optionally, at least one catalyst C; and
D) water.

### Steps of the Method

The method according to the invention comprises the following steps:
1) implementing the direct emulsion E of silicone in water;
2) heating the emulsion E to a temperature greater than or equal to 60° C. in order to obtain a porous silicone material; and
3) optionally, drying the porous silicone material, preferably by heating.

The heating step 2) is carried out at a temperature greater than or equal to 60° C., for example at a temperature comprised between 60 and 200° C. or between 70 and 180° C. Step 2) may last between 1 minute and 2 hours, for example between 10 minutes and 1 hour.

Those skilled in the art will know how to adapt the temperature and duration of step 2) according to the emulsion used and/or the desired porous silicone material.

At the end of step 2), a porous silicone material is obtained. This porous silicone material may be an elastomeric silicone foam. Depending on the temperature of step 2), this material may still comprise water, for example the material may be impregnated with water.

In certain cases, it may be necessary to dry the porous silicone material obtained after step 2), in a drying step 3). This drying step is optional; it may be carried out by heating the porous silicone material, far example to a temperature greater than or equal to 100° C. Advantageously, the porous silicone material is dried at a temperature comprised between 100 and 200° C., preferably between 100 and 150° C. It is also possible to allow the porous silicone material to air dry.

The heating step 2) and the drying step 3) may be concomitant. This can be the case when step 2) is carried out at a temperature greater than or equal to 100° C., for example at a temperature comprised between 100 and 200° C.

According to one particular embodiment, step is a step of coating a support with a direct emulsion E of silicone in water.

This coating step is the application of at least one layer of direct emulsion E of silicone in water, onto the support.

The coating step may in particular be carried out by doctor blade, in particular by doctor blade on cylinder, air doctor blade, and doctor blade on mat, by pad finishing, in particular by squeezing between two rollers or by wicking roller, rotating frame, reverse roller, by transfer, by screen printing, by photoengraving, or by spraying.

The coating is carried am on at least one of the faces of the support. The coating may be total or partial, meaning that the coating may be carried out on the entire surface of at least one of the faces of the support or on one or more portions of at least one of the faces of the support.

The layer of direct emulsion E of silicone in water may also impregnate the support, by penetrating inside the support.

The layer of direct emulsion E of silicone in water on the support may be on the order of a few hundred micrometers to a few millimeters.

The supports to be coated are generally fibrous supports, for example woven fabrics, nonwoven fabrics or knits or more generally any fibrous support comprising fibers and/or fibers chosen from the group of materials comprising: glass, silica, metals, ceramics, silicon carbide, carbon, boron, natural fibers such as cotton, wool, hemp, flax, artificial fibers such as viscose, or cellulosic fibers, synthetic fibers such as polyesters, polyamides, polyacrylics, chlorofibers, polyolefins, synthetic rubbers, polyvinyl alcohol, aramids, fluorofibers, phenolics, etc.

The supports to be coated include architectural textiles. “Architectural textile” is understood to mean a woven or non-woven fabric and more generally any fibrous support intended, after coating, for the manufacture of:
shelters, mobile structures, textile buildings partitions, flexible doors, tarpaulins, tents, stands, or pavilions;
furniture, cladding, billboards, windbreaks, or filter panels;
sun protections, ceilings, and blinds.

The invention also relates to a method for coaxing a support, comprising the following steps:
1) coating a support with a direct emulsion E of silicone in water comprising:
   A) a silicone base A crosslinkable by polycondensation or polyaddition;
   B) at least one nonionic silicone surfactant B having a cloud point comprised between 10 and 50° C., preferably between 15 and 45° C.;
   C) optionally, at least one catalyst C; and
   D) water;
2) heating the emulsion E to a temperature greater than or equal to 60° C. in order to obtain a porous silicone material; and
3) optionally, drying the porous, silicone material, preferably by heating.

### Direct Emulsion E of Silicone in Water

Another object of the invention is a direct emulsion E of silicone in water comprising
A) a silicone base A crosslinkable by polycondensation or polyaddition;
B) at least one nonionic silicone surfactant B having a cloud point comprised between 10 and 50° C., preferably between 15 and 45° C.;
C) optionally, at least one catalyst C; and
D) water.

The embodiments of the emulsion described above in the method section also apply to the direct emulsion E of silicone in water as such.

This direct emulsion E of silicone in water can be used to implement the method described above.

### Porous Silicone Material

Another object of the invention is a porous silicone material comprising at least one nonionic silicone surfactant B having a cloud point comprised between 10 and 50° C., preferably between 15 and 45° C. The amount of surfactant B may be comprised between 0.5 and 50% by mass of surfactant B relative to the total mass of the material, preferably between 1 and 25%, and more preferably between 2 and 15%.

Another object of the invention is a porous silicone material capable of being obtained by heating the direct emulsion E of silicone in water described above to a temperature greater than or equal to 60° C.

Advantageously, the material has a density of less than 0.9 g/cm³, preferably less than 0.6 g/cm³, and even more preferably less than 0.4 g/cm³.

The pore size of the porous silicone material may vary from a few μm to a few hundred μm.

The porous silicone material has an open and/or closed porosity. Preferably, the material has a predominantly open porosity.

According to one particular embodiment, the porous silicone material has a predominantly. open porosity and pores of a size less than or equal to 500 μm.

Support Coated with a Porous Silicone Material

Finally, an object of the invention is a support coated with a porous silicone material as described above. The support may be completely or partially coated. The support may also be impregnated with a porous silicone material as described above.

The support may be selected from the supports listed above.

### EXAMPLES

### Protocols

### Determination of Pore Size:

The size of the pores is determined by scanning electron microscopy or by tomography.

### Determination of the Cloud Point of Surfactants:

The surfactant is introduced at a mass concentration of 1% in distilled water, with constant stirring and with the temperature controlled by a hot plate. If the solution is clear at room temperature, the mixture is heated until complete opacity is obtained, then it is slowly cooled and the temperature at which the opacity disappears is determined. In the event that the solution is already opaque, or cloudy at room temperature, it is cooled and, similarly, the temperature at which the opacity disappears is determined. This temperature of the opacity disappearance constitutes the cloud point or cloud temperature of the surfactant.

### Preparation of Silicone-in-Water Emulsions:

At room temperature, the silicone base (A) crosslinkable by polyaddition is added to a beaker and mixed with the surfactant (B) for 3 minutes using an Ultra-Turrax type of rotor-stator at a speed of approximately 16,000 rpm. The water (D) is then gradually added for about 10 minutes while still stirring; this results in a direct emulsion of the silicone-in-water type which is white and fluid (except for comparative example 1.6).

Formation of Porous Silicone Material from Emulsions:

Karstedt platinum previously emulsified in water (C) is added to the silicone-in-water emulsion obtained above. The resulting catalyzed emulsion, which is a direct emulsion of the silicone-in-water type, is placed in a heated bath at 90° C. for 30 minutes. Once crosslinked, an impregnated porous material is obtained. It is rinsed three times with ethanol and then placed in an oven for two hours at 115° C.

Coating and Formation of a Thin Film of Foam from Emulsions:

The catalyzed emulsion is applied with a doctor blade on glass fabric previously rendered water-resistant, at the amount of approximately 50 grains per square meter. The coated fabric is baked in an oven at 1.20° C. for 10-20 minutes to allow formation of the porous material.

### Protocol for Measuring the Density of Porous Silicone Materials (p_{f}):

A foam parallelepiped is carefully cut out with scissors (typically: 7.5 g, 50 mm long (l), 30 mm wide (L), and 20 mm thick (e)). It is weighed (Ms). The density of the foam is calculated using the following calculation:

$$ρ f = \frac{Ms}{Vsample} = \frac{Ms}{l \times L \times e}$$

### Protocol for Measuring the Open Porosity Percentage (% PO):

A foam parallelepiped is carefully cut out with scissors (typically: 7.5 g, 50 mm long (l), 30 mm wide (L), and 20 mm thick (e)). It is first weighed dry (Ms) then immersed in a beaker of distilled water (50 mL); the whole is placed under reduced pressure (50 mbar) in a desiccator for 120 min. Next, the sample is removed, quickly dried on absorbent paper to eliminate water from the surface of the six sides of the parallelepiped, then immediately weighed (Mi). The open porosity percentage is obtained using the following calculation:

$$\% PO = \frac{Vwater}{Vcells} \times 100 = \frac{Mi - Ms}{( l \times L \times e ) - \frac{Ms}{ρ p}} \times 100$$

With: % PO open porosity percentage
V_{water} volume of water inserted into the foam
Mₛ initial mass of the foam parallelepiped
Mᵢ mass of the water-impregnated sample
l, L and e dimensions of the parallelepiped
ρₚ density of the silicone material (≈1 /cm³)

### Protocol for Measuring the Modulus of Compression:

Compression of the samples (cylindrical; cut out with a punch, 10 mm high by 10 mm in diameter) is carried out using a “Material Testing System” (MTS) machine at a rate of 200 mm/min. It is averaged over 10 samples per foam. The modulus E of compression is deduced via the gradient of the tangent to the curve in the elastic zone of the material.

### Protocol for Measuring Tensile Modulus and Elongation at Break:

The traction is carried out on dumbbell-shaped samples of type H2 using a “Material Testing System” (MTS) machine at a rate of 500 mm/min. The tensile modulus E is deduced via the gradient of the tangent to the curve in the elastic zone of the material. The elongation at break (A %) is deduced via the following calculation:

$$A \% = \frac{Lu - Lo}{Lo} \times 100$$

With: Lo length of the sample at rest before traction
Lu length of the sample just before breaking

### Reagents Used

In the examples, the amounts are expressed in parts by weight unless otherwise indicated.

HVII: polydimethylsiloxane oil blocked at each of the ends of the chains by a (CH₃)₂ViSiO_{1/2} unit, having a viscosity of 230 mPa·s

HL-12: polydimethylsiloxane oil blocked at each end of the ends of the chains by a (CH₃)₂ViSiO_{1/2} unit, having a viscosity of 1000 mPa·s

SiH1: Organohydrogenpolysiloxane having a mass percent of silyl hydride functions Si—H of 46%

SiH resin: MQ resin having a mass percent of silyl hydride functions Si—H of 26%

Platinum 909: platinum catalyst in emulsion form having a mass percent of platinum of 0.085%

SiH2 oil: Organohydrogenpolysiloxane having a mass percent of silyl hydride functions Si—H of 20%

SiH3 oil: Organohydrogenpolysiloxane having a mass percent of silyl hydride functions Si—H of 4.75%

Rhodopol®: xanthan-type gum

Rheozan®: succinoglycan gum

Various surfactants were tested:
organopolysiloxane-polyoxyalkylene copolymers (nonionic silicone surfactants) from Siltech (Silsurf® A010-D-UP) and Evonik (Tegopren® family)
non silicone surfactants, with a carbonaceous fatty chain and ethoxylated chain (Rhodasurf® ROX and Brij®)

The characteristics of the various surfactants used are presented in Tables 1 and 2 below.

TABLE 1
characteristics of the organopolysiloxane-polyoxyalkylene
copolymers

| | | | EO/ | | | Cloud |
|---|---|---|---|---|---|---|
| | Mw | | PO | | Si/ | point |
| | (g/ | Mw/ | func- | EO/PO | organic | in ° C. |
| Surfactant | mol) | Mn | tions | wt % | wt % | (1% wt) |
| Tegopren ® 5831 | 7000 | 3.66 | 40/60 | 34/66 | 75/25 | <0 |
| Tegopren ® 5840 | 300 | 3.55 | 59/41 | 52/48 | 34/66 | 25 |
| Tegopren ® 5847 | 550 | 1.27 | 77/23 | 72/28 | 33/67 | 57 |
| Tegopren ® 5851 | n/a | n/a | 72/28 | 67/33 | 33/67 | 67 |
| Tegopren ® 5852 | 1700 | 2.74 | 25/75 | 20/80 | 33/67 | 18 |
| Tegopren ® 5863 | 1200 | 2.24 | 39/61 | 32/68 | 25/75 | 43 |
| Tegopren ® 5878 | 550 | 1.21 | 100/0 | 100/0 | 42/58 | 16 |
| Silsurf ® A010- | 1000 | 1.17 | 72/28 | 66/34 | 31/69 | 43 |
| D-UP | | | | | | |

TABLE 2
characteristics of non-silicone surfactants

| | Cloud point in |
|---|---|
| | ° C. (1% wt) |
| Rhodasurf ® ROX | 44 |
| Brij ® C10 | 63 |
| Brij ® C20 | 95 |

### EXAMPLE 1

### Impact of the Structure of the Surfactant and of its Cloud Point

The various surfactants were tested, and the properties of the porous silicone materials were determined (see Tables 3 and 4).

TABLE 3
Examples 1.1 to 1.6 according to the invention

| | Ex 1.1 | Ex 1.2 | Ex 1.3 | Ex 1.4 | Ex 1.5 | Ex 1.6 |
|---|---|---|---|---|---|---|
| HVI1 | 100 | 100 | 100 | 100 | 100 | 100 |
| HVI2 | 18.2 | 18.2 | 18.2 | 18.2 | 18.2 | 18.2 |
| SiH1 oil | 2.5 | 2.5 | 2.5 | 2.5 | 2.5 | 2.6 |
| SiH resin | 1.2 | 1.2 | 1.2 | 1.2 | 1.2 | |
| Platinum 909 | 7.1 | 7.1 | 7.1 | 7.1 | 7.1 | 7.1 |
| Distilled water | 224 | 224 | 224 | 224 | 224 | 224 |
| Tegopren ® | 25.6 | | | | | 25.6 |
| 5840 | | | | | | |
| Tegopren ® | | | 25.6 | | | |
| 5863 | | | | | | |
| Tegopren ® | | | | 25.6 | | |
| 5878 | | | | | | |
| Tegopren ® | | 25.6 | | | | |
| 5852 | | | | | | |
| Silsurf ® | | | | | 25.6 | |
| A010-D-UP | | | | | | |
| Type of emul- | direct | direct | direct | direct | direct | direct |
| sion obtained | | | | | | |
| Density | 0.19 | 0.26 | 0.21 | 0.24 | 0.19 | 0.21 |
| (g/cm³) | | | | | | |
| % Open/ | 70/11 | 45/29 | 65/14 | 55/21 | Not | Open at |
| % Closed | | | | | meas- | 55% |
| Porosity | | | | | ured | |
| Surfactant | 25 | 18 | 43 | 16 | 43 | 25 |
| cloud | | | | | | |
| point (° C.) | | | | | | |
| Pore size (μm) | 220- | 400- | 60- | 430- | Not | 60- |
| | 400 | 650 | 100 | 500 | meas- | 300 |
| | | | | | ured | |
| Molar ratio | 1.89 | 1.89 | 1.89 | 1.89 | 1.89 | 1.57 |
| H/Vi | | | | | | |

TABLE 4
Comparative examples 1.1 to 1.6

| | Comp. | Comp. | Comp. | Comp. | Comp. | Comp. |
|---|---|---|---|---|---|---|
| | Ex. | Ex. | Ex. | Ex. | Ex. | Ex. |
| | 1.1 | 1.2 | 1.3 | 1.4 | 1.5 | 1.6 |
| HVI1 | 100 | 100 | 100 | 100 | 100 | 100 |
| HVI2 | 18.2 | 18.2 | 18.2 | 18.2 | 18.2 | 18.2 |
| SiH1 oil | 2.5 | 2.5 | 2.5 | 2.5 | 2.5 | 2.5 |
| SiH resin | 1.2 | 1.2 | 1.2 | 1.2 | 1.2 | 1.2 |
| Platinum 909 | 7.1 | 7.1 | 7.1 | 7.1 | 7.1 | 7.1 |
| Distilled water | 224 | 224 | 224 | 224 | 224 | 224 |
| Brij ® C10 | 25.6 | | | | | |
| Brij ® C20 | | 25.6 | | | | |
| Tegopren ® 5847 | | | 25.6 | | | |
| Tegopren ® 5851 | | | | 25.6 | | |
| Rhodasurf ® ROX | | | | | 25.6 | |
| Tegopren ® 5831 | | | | | | 25.6 |
| Type of emulsion | direct | direct | direct | direct | direct | invert |
| obtained | | | | | | |
| Density (g/cm³) | n/a | n/a | n/a | n/a | n/a | / |
| % Open/% Closed | n/a | n/a | n/a | n/a | n/a | / |
| Porosity | | | | | | |
| Surfactant | 63 | 95 | 57 | 62 | 44 | <0 |
| cloud point | | | | | | |
| (° C.) | | | | | | |
| Pore size (μm) | n/a | n/a | n/a | n/a | n/a | / |
| Molar ratio H/Vi | 1.89 | 1.89 | 1.89 | 1.89 | 1.89 | 1.89 |

Examples 1.1 to 1,6 according to the invention (Table 3) were carried out with nonionic silicone surfactants having cloud points comprised between 10 and 50° C. according to the invention. These surfactants allow the formation of a direct emulsion of silicone in water and the porous silicone materials obtained are of good quality: they are not friable. Furthermore, the porosity of the porous silicone materials obtained is mainly open and the density of the materials is low (<0.3 g/cm³). The average pore size varies from a few tens of μm to a few hundred μm.

Comparative Examples 1.1 and 1.2 (Table 4) were carried out with non-silicone surfactants having high cloud points (>50° C.). These surfactants allow the formation of a direct emulsion of silicone in water, but no porous silicone material was obtained during these tests.

Comparative Examples 1.3 and 1.4 (Table 4) were carried out with nonionic silicone surfactants haying high cloud points (>50° C.). These surfactants allow the formation of a silicone emulsion in water, but the porous silicone materials obtained are not of good quality because they are friable. It therefore is not possible to use them or to determine their properties.

Comparative Example 1.5 (Table 4) was carried out with a non-silicone surfactant having a cloud point comprised between 10 and 50° C. This surfactant allows the formation of a silicone emulsion in water, but no porous silicone material was obtained during this test.

Comparative Example 1.6 (Table 4) was carried out with a nonionic silicone surfactant having a low cloud point (<0° C.). This surfactant does not allow the formation of a silicone emulsion in water, therefore no porous silicone material was obtained during this test.

In view of these tests, it is therefore necessary to use a nonionic silicone surfactant having a cloud point comprised between 10 and 50° C. in order to obtain a porous silicone material of good quality.

### EXAMPLE 2

### Impact of the Concentration of Surfactant

Tegopren® 5840 surfactant was used. The amount of surfactant was varied from 2.5 to 50% by mass relative to the mass of silicone for this example. The density of the porous silicone materials obtained was determined (see Table 5).

TABLE 5
Examples 2.1 to 2.7

| | Ex 2.1 | Ex 2.2 | Ex 2.3 | Ex 2.4 | Ex 2.5 | Ex 2.6 | Ex 2.7 |
|---|---|---|---|---|---|---|---|
| HVI1 | 100 | 100 | 100 | 100 | 100 | 100 | 100 |
| HVI2 | 18.2 | 18.2 | 18.2 | 18.2 | 18.2 | 18.2 | 18.2 |
| SiH1 oil | 2.5 | 2.5 | 2.5 | 2.5 | 2.5 | 2.5 | 2.5 |
| SiH resin | 1.2 | 1.7 | 1.2 | 1.2 | 1.2 | 1.2 | 1.2 |
| Platinum 909 | 7.1 | 7.1 | 7.1 | 7.1 | 7.1 | 7.1 | 7.1 |
| Distilled water | 224.0 | 224.0 | 224.0 | 224.0 | 224.0 | 224.0 | 224.0 |
| Tegopren ® 5840 | 3.8 | 6.4 | 12.8 | 25.6 | 38.4 | 51.2 | 64.0 |
| Density (g/cm³) | 0.38 | 0.34 | 0.20 | 0.18 | 0.24 | 0.26 | 028 |

All the concentrations tested allow obtaining a porous silicone material of good quality.

### EXAMPLE 3

### Impact of the Amount of Water in the Emulsion

Tegopren® 5840 surfactant was used. The amount of water in the emulsion was varied from 10 to 70% by mass relative to the mass of silicone for this example. The density of the porous silicone materials obtained was determined (see Table 6).

TABLE 6
Examples 3.1 to 3.7

| | Ex 3.1 | Ex 3.2 | Ex 3.3 | Ex 3.4 | Ex 3.5 | Ex 3.6 | Ex 3.7 |
|---|---|---|---|---|---|---|---|
| HVI1 | 100 | 100 | 100 | 100 | 100 | 100 | 100 |
| HVI2 | 18.2 | 18.2 | 18.2 | 18.2 | 18.2 | 18.2 | 18.2 |
| SiH1 oil | 2.5 | 2.5 | 2.5 | 2.5 | 2.5 | 2.5 | 2.5 |
| SiH resin | 1.2 | 1.2 | 1.2 | 1.2 | 1.2 | 1.2 | 1.2 |
| Platinum 909 | 7.1 | 7.1 | 7.1 | 7.1 | 7.1 | 7.1 | 7.1 |
| Water | 20.0 | 45.0 | 77.0 | 120.0 | 180.0 | 270.0 | 421.0 |
| Tegopren ® 5840 | 25.6 | 25.6 | 25.6 | 25.6 | 25.6 | 25.6 | 25.6 |
| Density (g/cm³) | 0.75 | 0.69 | 0.55 | 0.32 | 0.28 | 0.18 | 0.24 |

All the examples allow obtaining a porous silicone material of good quality. Since the emulsion contains more than 35% water by mass, the density of the material is relatively low.

### EXAMPLE 4

### Impact of Si—H Oil

Different Si—H oils with different mass percents of silyl hydride functions Si—H were tested. The ratio remains substantially the same for these tests. The density of the porous silicone materials obtained was determined (see Table 7).

TABLE 7
Examples 4.1 to 4.3

| | Ex 4.1 | Ex 4.2 | Ex 4.3 |
|---|---|---|---|
| HVI1 | 100 | 1.00 | 100 |
| HVI2 | 18.2 | 18.2 | 18.2 |
| SiH1 oil | 2.5 | | |
| SiH2 oil | | 6.7 | |
| SiH3 oil | | | 27.7 |
| SiH resin | 1.2 | 1.2 | 1.2 |
| Platinum 909 | 7.1 | 7.1 | 7.1 |
| Distilled water | 224.0 | 224.0 | 224.0 |
| Tegopren ® 5840 | 12.8 | 12.8 | 12.8 |
| Density (g/cm³) | 0.20 | 0.67 | 0.86 |
| Molar ratio H/Vi | 1.89 | 2.13 | 2.10 |

These results show that it is possible to obtain porous silicone materials with different SiH oils. The mass percent of silyl hydride functions Si—H has an influence on the density of the material. In the case Where the mass percent of silyl hydride functions Si—H in the organohydrogenpolysiloxane is high (example 4.1), the density of the material obtained is lower.

### EXAMPLE 5

### Coating of a Support

As the emulsion is very fluid, two thickeners have also been added to increase its viscosity: Rhodopol® (a xanthan-type gum) and Rheozan® (a succinoglycan gum). The viscosity of the emulsions goes from 0.1 Pa·s to approximately 100 Pa·s. The properties of the porous materials obtained from these emulsions were determined. The results are presented in Table 8.

TABLE 8
Examples 5.1 to 5.3

| | Ex 5.1 (= Ex 2.3) | Ex 5.2 | Ex 5.3 |
|---|---|---|---|
| HVI1 | 100 | 100 | 100 |
| HVI2 | 18.2 | 18.2 | 18.2 |
| SiH1 oil | 2.5 | 2.5 | 2.5 |
| SiH resin | 1.2 | 1.2 | 1.2 |
| Platinum 909 | 7.1 | 7.1 | 7.1 |
| Distilled water | 224.0 | 224.0 | 224.0 |
| Tegopren ® 5840 | 12.8 | 12.8 | 12.8 |
| Rheozan ® | | 4.48 | |
| Rhodopol ® | | | 4.48 |
| Density (g/cm³) | 0.20 | 0.22 | 0.21 |
| % Open/% Closed Porosity | 65/15 | 54/33 | 72/7 |

These results show that the addition of thickeners has no effect on the density of the material obtained and the porosity of the material remains mainly open,

Furthermore, emulsions comprising a thickener (Ex. 5.2 and 5.3) were used to coat a fiberglass support. A support coated with a layer of porous silicone material was obtained in both cases. These results show that it is possible to use the method according to the invention to produce a support coated with a porous silicone material.

### EXAMPLE 6

### Mechanical Properties of the Porous silicone Materials

The mechanical properties of a porous silicone material according to the invention have been determined. The results are presented in Table 9.

TABLE 9
Example 6.1

| | Ex 6.1 |
|---|---|
| HVI1 | 100 |
| HVI2 | 18.2 |
| SiH1 oil | 2.5 |
| SiH resin | 1.2 |
| Platinum 909 | 7.1 |
| Water | 290.0 |
| Tegopren ® 5840 | 25.6 |
| Density (g/cm³) | 0.20 |
| Open porosity | 51% |
| Modulus of compression E (kPa) | 17.1 |
| Tensile modulus E (kPa) | 14.2 |
| Elongation at break | 47% |

These results show that the porous silicone materials according to the invention have good mechanical properties.

1. A method for producing a porous silicone material, comprising the following steps:
1) implementing a direct emulsion E of silicone in water comprising:
A) a silicone base A crosslinkable by polycondensation or polyaddition;
B) at least one nonionic silicone surfactant B having a cloud point comprised between 10 and 50° C., preferably between 15 and 45° C.;
C) optionally, at least one catalyst C; and
D) water;
2) heating the emulsion E to a temperature greater than or equal to 60° C. to obtain a porous silicone material; and
3) optionally, drying the porous silicone material, preferably by heating.

2. Method according to claim 1, wherein the nonionic silicone surfactant B is an organopolysiloxane-polyoxyalkylene copolymer, preferably comprising siloxyl units having sequences of ethylene oxide chains, and, optionally, sequences of propylene oxide chains.

3. Method according to claim 1, wherein the nonionic silicone surfactant B is selected from organopolysiloxane-polyoxyalkylene copolymers comprising siloxyl units of formula (B-1)
[Rₐ¹Z_{b}SiO_{(4-a-b)/2}]n (B-1)
in which
the R¹ radicals, which are identical or different, represent a hydrocarbon radical having from 1 to 30 carbon atoms, preferably selected from alkyl groups having from 1 to 8 carbon atoms and aryl groups having from 6 to 12 carbon atoms
n is an integer greater than or equal to 2;
a and b are independently 0, 1, 2, or 3, and a+b =0, 1, 2, or 3;
each Z radical is a —R²—(OCₚH₂ₚ)_{q}(OCᵣH₂ᵣ)ₛ—OR³ group,
where
R² is a divalent hydrocarbon group having from 2 to 20 carbon atoms, or a bond;
R³ is H or an R¹ group as defined above,
p and r are, independently, an integer between 1 and 6;
q and s are, independently, 0 or an integer such that 1<q+s<400;
and each molecule of organopolysiloxane-polyoxyalkylene copolymer B comprises at least one Z group.

4. Method according to claim 1, wherein the emulsion E comprises between 0.1 and 70% by mass of surfactant B relative to the total mass of silicone base contained in the emulsion, preferably between 0.5 and 50%, more preferably between 1 and 25%, and even more preferably between 2 and 20%.

5. Method according to claim 1, wherein the emulsion E comprises between 10 and 80% of water by mass relative to the total mass of the emulsion, preferably between 30 and 75%, and even more preferably between 35 and 65%.

6. Method according to claim 1, wherein the silicone base A is crosslinkable by polyaddition and wherein the silicone base A comprises:
at least one organopolysiloxane A1 comprising, per molecule, at least 2 alkenyl or alkynyl groups, linear or branched, having from 2 to 6 carbon atoms, and
at least one organohydrogenpolysiloxane A2 comprising, per molecule, at least 2 silyl hydride functions Si—H.

7. Method according to claim 1, wherein the silicone base A is crosslinkable by polycondensation and wherein the silicone base A comprises
at least one organopolysiloxane A3 comprising at least two OH functional groups or at least two hydrolyzable functional groups, and
optionally, at least one crosslinking agent A4.

8. Method according to claim 1, wherein the emulsion E also comprises at least one thickener F.

9. Method according to claim 1, wherein step 1) is a step of coating a support with a direct emulsion E of silicone in water.

10. Direct emulsion E of silicone in water, comprising
A) a silicone base A crosslinkable by polycondensation or polyaddition;
B) at least one nonionic silicone surfactant B having a cloud point comprised between 10 and 50° C., preferably between 15 and 45° C.;
C) optionally, at least one catalyst C; and
D) water.

11. Porous silicone material comprising at least one nonionic silicone surfactant B having a cloud point comprised between 10 and 50° C., preferably between 15 and 45° C.

12. Porous silicone material obtained by heating the emulsion E according to claim 10 to a temperature greater than or equal to 60° C.

13. Support coated with a porous silicone material according to claim 11.

14. Support coated with a porous silicone material according to claim 12.
